(19) United States
(12) Patent Application Publication
(10) Pub. No.: US 2026/0287973 A1
(43) Pub. Date: Sep. 24, 2026

(54) CAMERA MODULE

(71) Applicant: Samsung Electro-Mechanics Co., Ltd., Suwon-si (KR)

(72) Inventors: Bo Sung SEO, Suwon-si (KR); Nam Ju LEE, Suwon-si (KR); Young Hwan KWON, Suwon-si (KR); Young Bok YOON, Suwon-si (KR); Ki Ho LEE, Suwon-si (KR); Byung Woo KANG, Suwon-si (KR)

(73) Assignee: Samsung Electro-Mechanics Co., Ltd., Suwon-si (KR)

(21) Appl. No.: 19/572,260

(22) Filed: Mar. 19, 2026

(30) Foreign Application Priority Data
Mar. 21, 2025 (KR) 10-2025-0036879
Feb. 12, 2026 (KR) 10-2026-0028796

(51) Int. Cl. G03B 3/10; G02B 7/10; G03B 13/34; G03B 17/12; H02K 33/18

(52) U.S. Cl. CPC G03B 3/10; G02B 7/10; G03B 13/34; G03B 17/12; H02K 33/18

(57) ABSTRACT

A camera module includes a housing, a first lens module disposed in the housing and movable relative to the housing in an optical-axis direction, and a plurality of guide parts configured to support movement of the first lens module, wherein one or more guide parts among the plurality of guide parts includes an accommodating groove, a guide protrusion disposed in the accommodating groove and extending in a first-axis direction perpendicular to the optical-axis direction, and a plurality of balls disposed to surround the guide protrusion.

### CROSS-REFERENCE TO RELATED APPLICATIONS

This application claims the benefit under 35 USC 119(a) of Korean Patent Application Nos. 10-2025-0036879 filed on Mar. 21, 2025, and 10-2026-0028796 filed on Feb. 12, 2026, in the Korean Intellectual Property Office, the entire disclosures of which are incorporated herein by reference for all purposes.

### BACKGROUND

### 1. Field

The present disclosure relates to a camera module.

### 2. Description of the Background

In recent years, a camera module has been employed in a mobile communication terminal such as a smartphone, a tablet personal computer (PC), a laptop computer, or the like. In addition, the camera module may include a focus adjustment function in order to generate a high-resolution image.

During focus adjustment, a lens module may move in an optical axis direction, and here, a plurality of ball members or the like may be used in order to support movement of the lens module in the optical axis direction.

When the lens module is moved in the optical axis direction, each of the plurality of ball members may roll along the optical axis direction, thus requiring a guide groove design corresponding to a distance by which each of the plurality of ball members moves.

That is, when a movement distance of the lens module increases, a length of a guide groove in which each of the plurality of ball members is accommodated may thus also increase.

Accordingly, it may be difficult to reduce a size of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a first lens module disposed in the housing and movable relative to the housing in an optical-axis direction, and a plurality of guide parts configured to support movement of the first lens module, wherein at least one guide part among the plurality of guide parts includes an accommodating groove, a guide protrusion disposed in the accommodating groove and extending in a first-axis direction perpendicular to the optical-axis direction, and a plurality of balls disposed to surround the guide protrusion.

The plurality of balls may include a first ball in contact with both the first lens module and the housing, and a second ball spaced apart from the first ball in a second-axis direction perpendicular to both the optical-axis direction and the first-axis direction.

A movement direction of the first ball may be opposite to a movement direction of the second ball.

As the first lens module moves in the optical-axis direction, at least one ball among the plurality of balls may move in a direction opposite to a movement direction of the first lens module.

As the first lens module moves in the optical-axis direction, at least one ball among the plurality of balls may change a position thereof in a second-axis direction perpendicular to both the optical-axis direction and the first-axis direction.

The plurality of balls may be continuously circulable along a circumference of the guide protrusion.

The accommodation groove may be disposed in one of the housing and the first lens module. A guide groove may be disposed in another of the housing and the first lens module. At least one of the plurality of balls may be in contact with both the guide protrusion and the guide groove.

The plurality of balls may include a first ball in contact with both the first lens module and the housing. A portion of the first ball may be exposed to an exterior of the accommodation groove.

The guide protrusion may include a plurality of straight portions disposed parallel to each other and a plurality of curved portions connecting the plurality of straight portions to each other.

A length of each of the plurality of straight portions may be greater than a diameter of each of the plurality of balls.

The plurality of balls may include a first ball in contact with both the first lens module and the housing. The guide protrusion may include a first guide protrusion and a second guide protrusion disposed adjacent to each other in the first-axis direction. The first ball may be in contact with each of the first guide protrusion and the second guide protrusion.

The one or more guide parts may further include a cover coupled to the accommodation groove. The guide protrusion may include a first guide protrusion extending from a bottom surface of the accommodation groove in the first-axis direction, and the cover may include a second guide protrusion extending toward the first guide protrusion.

Each of the plurality of balls may be in contact with each of the first guide protrusion and the second guide protrusion.

A space defined by the accommodation groove and the cover may have one side open.

At least one ball among the plurality of balls may be exposed to an exterior of the space defined by the accommodation groove and the cover through the one open side.

The plurality of guide parts may include a first guide part and a second guide part spaced apart from each other in the optical axis direction and configured to support one side of the first lens module, and a third guide part configured to support another side of the first lens module, the other side being spaced apart from the one side of the first lens module in the first-axis direction.

The camera module may further include a second lens module disposed in the housing and movable relative to the housing in the optical-axis direction. The plurality of guide parts may be further configured to support movement of the second lens module.

The number of the plurality of balls may be seven or more.

In another general aspect, a camera module includes a housing, a lens module configured to be movable relative to the housing in an optical axis direction, and a plurality of guide parts configured to support movement of the lens module, wherein the plurality of guide parts include a first guide part and a second guide part spaced apart from each other in the optical axis direction and configured to support one side of the lens module, and a third guide part configured to support another side of the lens module, and wherein one or more guide parts among the first guide part to the third guide part includes a plurality of balls, and a circulating path in which the plurality of balls are disposed.

The one or more guide parts may further include an accommodating groove disposed in one of the housing and the lens module, a guide groove disposed in another of the housing and the lens module, and a guide protrusion disposed in the accommodating groove and extending in a direction perpendicular to the optical axis direction. The circulating path may be defined by the accommodating groove, the guide protrusion, and the guide groove.

As the lens module moves in the optical axis direction, a ball that is in contact with both the lens module and the housing among the plurality of balls may change.

In another general aspect, a camera module includes a lens module configured to be disposed in a housing and movable relative to the housing in an optical-axis direction, and a guide part configured to support movement of the lens module, wherein the guide part comprises an accommodating groove, a guide protrusion disposed in the accommodating groove and extending in a first-axis direction perpendicular to the optical-axis direction, and a plurality of balls configured to circulate continuously about the guide protrusion.

The plurality of balls may include a first ball configured to support the lens module on the housing, and a second ball spaced apart from the first ball in a second-axis direction perpendicular to both the optical-axis direction and the first-axis direction.

One or more of a first guide part and a second guide part may be spaced apart from each other in the optical axis direction and configured to support one side of the lens module, and a third guide part may be configured to support another side of the lens module, the other side being spaced apart from the one side of the lens module in the first-axis direction. One or more of the first guide part to the third guide part may include the guide part.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is an exploded perspective view of the camera module according to an example embodiment of the present disclosure.

FIG. 3 is an exploded perspective view of the housing, first lens module, and second lens module of the camera module according to an example embodiment of the present disclosure.

FIG. 4 is a perspective view of the first lens module.

FIG. 5 is a bottom perspective view of the first lens module illustrated in FIG. 4.

FIG. 6 is a perspective view of the second lens module.

FIG. 7 is a bottom perspective view of the second lens module illustrated in FIG. 6.

FIG. 8 is an exploded perspective view of a circulation guide part disposed in the first lens module.

FIG. 9 is an enlarged view of part A illustrated in FIG. 8.

FIGS. 10A through 10D are views illustrating a state in which a plurality of balls move in the circulation guide part.

FIG. 11 is a cross-sectional view taken along line B-B' of FIG. 10A.

FIG. 12 is a modified example of FIG. 11.

FIG. 13 is a plan view of the housing of the camera module according to an example embodiment of the present disclosure.

FIGS. 14 through 16 illustrate various example embodiments in which the circulation guide part is applied to the first lens module and the second lens module.

FIG. 17 is a schematic perspective view of the first lens module and the housing according to another example embodiment of the present disclosure.

FIG. 18 is an exploded perspective view of part of a reflective module and the housing.

FIG. 19 is a plan view of a protrusion of the housing.

FIG. 20 is a bottom view of the guide member and holder of the reflective module.

FIGS. 21 and 22 are views illustrating attractive force and repulsive force acting between a first magnetic part and a second magnetic part.

FIG. 23 is an exploded perspective view of the reflective module.

FIG. 24 is a view illustrating a positional relationship among a first driving unit, a first ball member, and a second ball member.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a camera module capable of being miniaturized.

The present disclosure relates to a reflective module and a camera module including the same, and the camera module may be mounted in a portable electronic device such as a mobile communication terminal, a smartphone, or a tablet personal computer (PC).

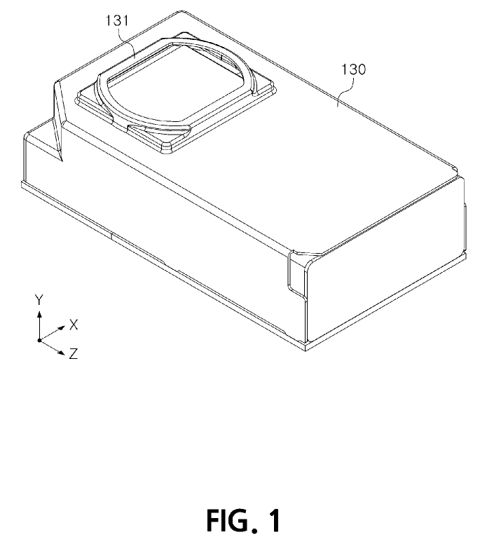

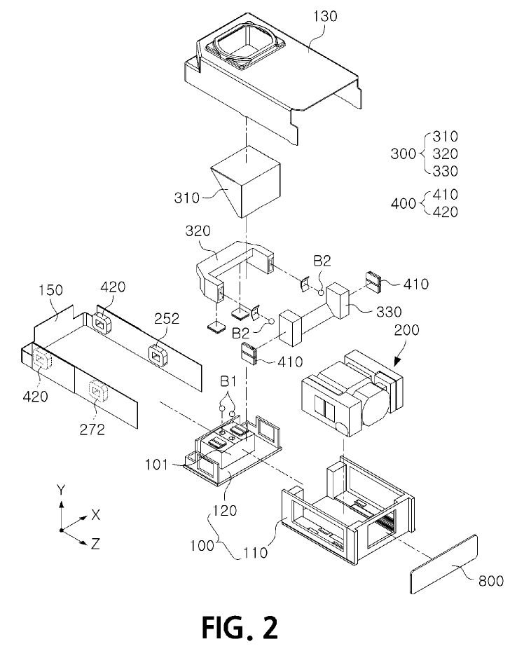

FIG. 1 is a perspective view of a camera module according to an example embodiment of the present disclosure; and FIG. 2 is an exploded perspective view of the camera module according to an example embodiment of the present disclosure.

Referring to FIGS. 1 and 2, the camera module according to an example embodiment of the present disclosure may include a lens unit 200 and a housing 100.

The camera module may include the lens unit 200. The lens unit 200 may include one or more lens modules. The lens module may include one or more lenses and may be disposed in the housing 100.

In an example embodiment, the lens unit 200 may include a first lens module 210 and a second lens module 230.

Each of the first lens module 210 and the second lens module 230 may include one or more lenses and may be disposed along an optical axis (Z-axis) direction. An optical axis (Z-axis) may pass through the centers of one or more lenses included in the first lens module 210 and the centers of one or more lenses included in the second lens module 230.

One or more lens modules among the first lens module 210 and the second lens module 230 may include a lens having a non-circular planar shape. For example, the lens having the non-circular planar shape may have different lengths in two directions perpendicular to the optical axis (Z-axis) direction and perpendicular to each other.

In an example embodiment, the lens having the non-circular planar shape may have a length in a first axis (X-axis) direction perpendicular to the optical axis (Z-axis) direction that is greater than a length in a second axis (Y-axis) direction perpendicular to the optical axis (Z-axis) direction.

In the specification, the first axis (X-axis) direction and the second axis (Y-axis) direction are examples of two directions perpendicular to the optical axis (Z-axis) and intersecting each other, and the first axis (X-axis) direction and the second axis (Y-axis) direction may be understood as two directions perpendicular to the optical axis (Z-axis) and intersecting each other.

One or more lens modules among the first lens module 210 and the second lens module 230 may move along the optical axis (Z-axis) direction.

In an example embodiment, one of the first lens module 210 and the second lens module 230 may move in the optical axis (Z-axis) direction to implement an optical zoom function.

In an example embodiment, each of the first lens module 210 and the second lens module 230 may move in the optical axis (Z-axis) direction to implement the optical zoom function.

In an example embodiment, the first lens module 210 and the second lens module 230 may move together in the optical axis (Z-axis) direction to implement a focus adjustment function.

The camera module may further include an image sensor 800.

The image sensor 800 may have an imaging surface, and light passing through the lens unit 200 may be received on the imaging surface.

The camera module may include a reflective module 300.

The reflective module 300 may include a reflective member 310 having a reflective surface and may be disposed in the housing 100.

The reflective member 310 may be rotatably disposed about two different axes for image stabilization. For example, the reflective member 310 may rotate about two axes perpendicular to each other in the housing 100. The reflective member 310 may rotate about the two axes perpendicular to each other relative to the housing 100.

The reflective module 300 may be disposed at one of or both of the front and the rear of the lens unit 200. The front of the lens unit 200 refers to a position closer to an object side than the lens unit 200 in the optical axis (Z-axis) direction, and the rear of the lens unit 200 refers to a position closer to an imaging surface side than the lens unit 200 in the optical axis (Z-axis) direction.

In the specification, an example embodiment is described in which the reflective module 300 is disposed in front of the lens unit 200. However, the reflective module 300 may be disposed at the rear of the lens unit 200, and may also be disposed at both the front and rear of the lens unit 200.

The housing 100 may include a first housing 110 and a second housing 120. The lens unit 200 may be disposed in the first housing 110, and the reflective module 300 may be disposed in the second housing 120.

The first housing 110 and the second housing 120 may be coupled to each other. Alternatively, the first housing 110 and the second housing 120 may be integrally formed to form one housing 100.

The camera module may further include a case 130. The case 130 may be coupled to the housing 100 to cover an upper portion of the housing 100. The case 130 may include an opening, and light may be incident on the reflective module 300 through the opening.

Meanwhile, a cap 131 may be coupled to the opening of the case 130. The cap 131 may be coupled to an edge of the opening of the case 130. The cap 131 may have a through hole to allow light to be incident into the camera module. The through hole in the cap 131 may have a track shape having a straight portion and a curved portion. For example, the through hole in the cap 131 may have two straight sections and two curved sections (e.g., semicircular curved sections).

At least one of the edges of the case 130 adjacent to the cap 131 may include a stepped portion. For example, referring to FIG. 1, at least one of two edges of the case 130 adjacent to the cap 131 may include a stepped portion.

The stepped portion may be stepped from an upper surface of the case 130.

In addition, a stepped portion may also be formed at an edge of the housing 100 corresponding to one side edge of the case 130.

Accordingly, a thickness of one side edge of the case 130 (in the second axis (Y-axis) direction) may be smaller than other portions. Accordingly, space utilization of a region in which the camera module is mounted in a portable electronic device may be improved.

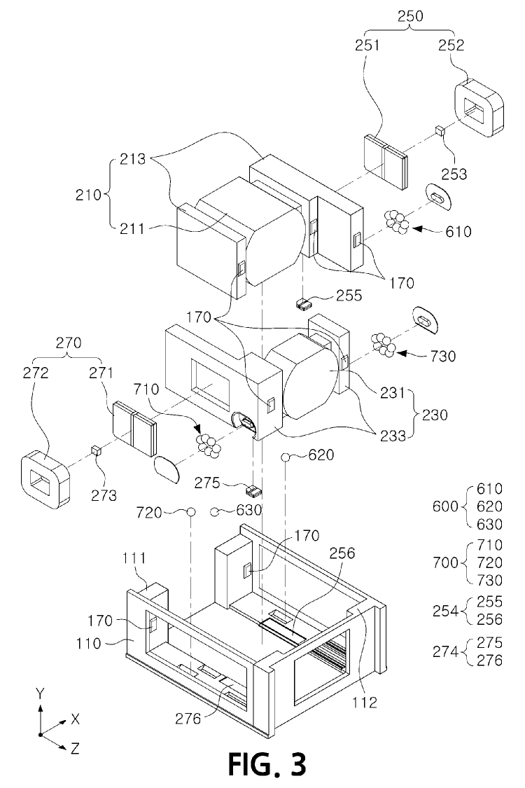

FIG. 3 is an exploded perspective view of the housing, first lens module, and second lens module of the camera module according to an example embodiment of the present disclosure.

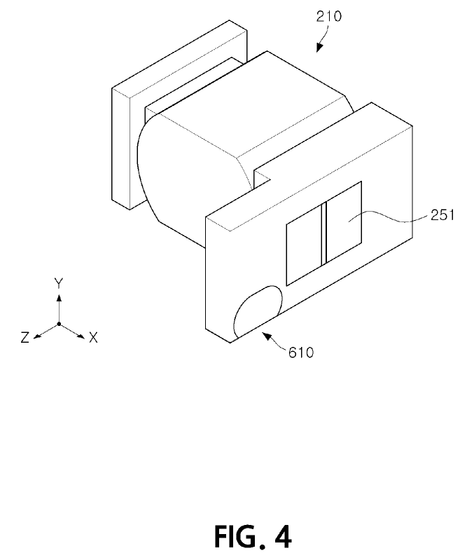

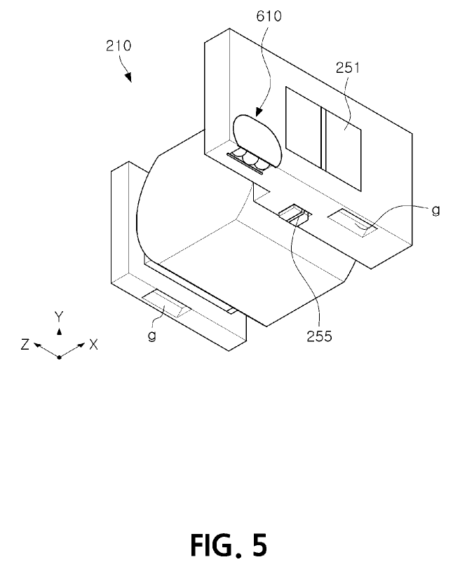

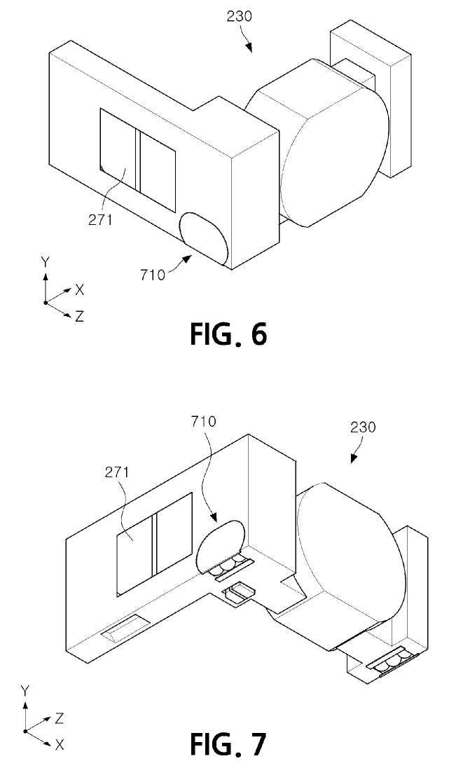

In addition, FIG. 4 is a perspective view of the first lens module; FIG. 5 is a bottom perspective view of the first lens module illustrated in FIG. 4; FIG. 6 is a perspective view of the second lens module; and FIG. 7 is a bottom perspective view of the second lens module illustrated in FIG. 6.

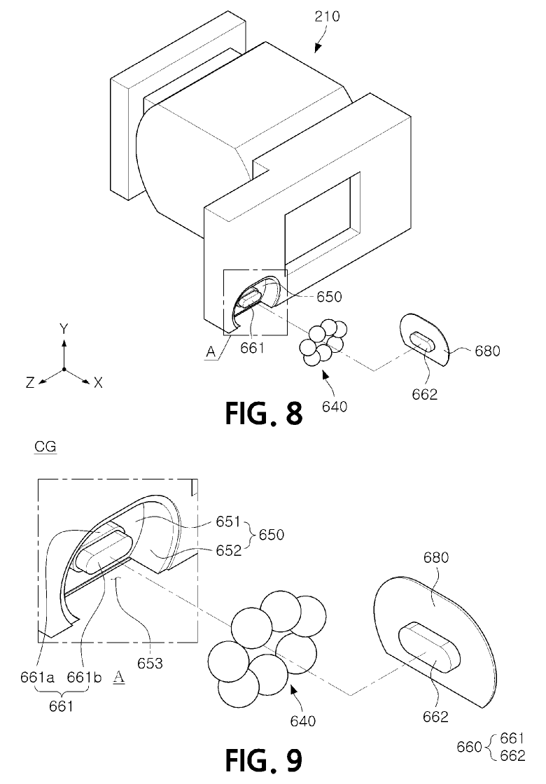

In addition, FIG. 8 is an exploded perspective view of a circulation guide part disposed in the first lens module; and FIG. 9 is an enlarged view of part A illustrated in FIG. 8.

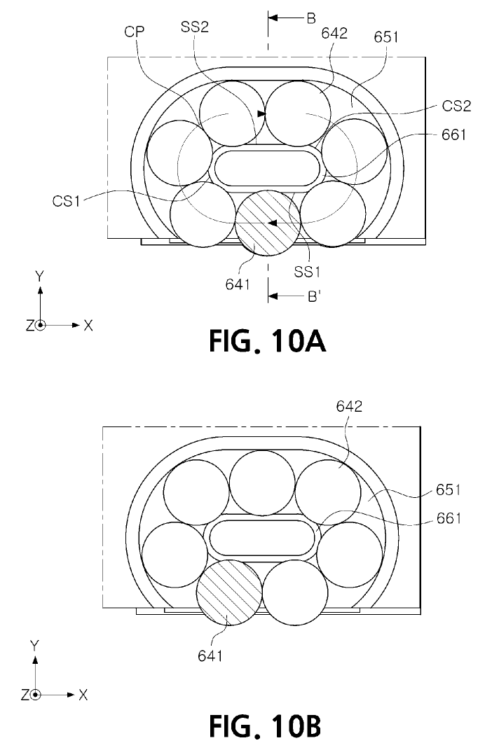

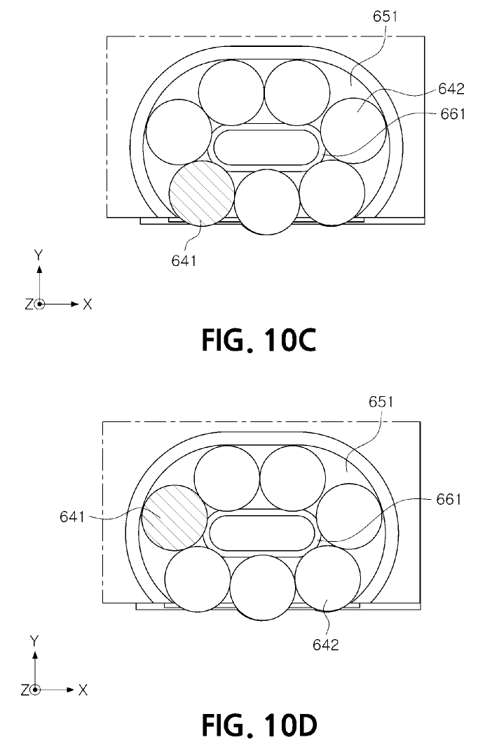

In addition, FIGS. 10A through 10D are views illustrating a state in which a plurality of balls move in the circulation guide part.

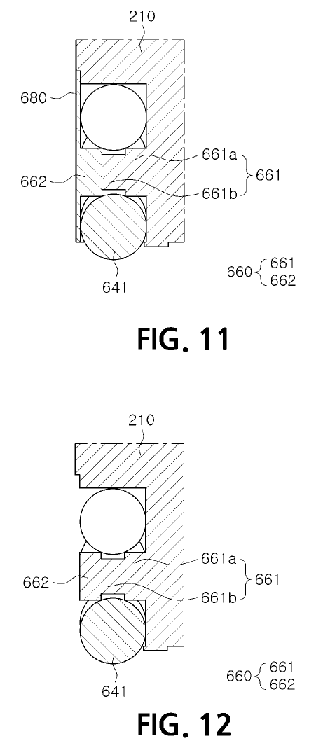

In addition, FIG. 11 is a cross-sectional view taken along line B-B' of FIG. 10A; and FIG. 12 is a modified example of FIG. 11.

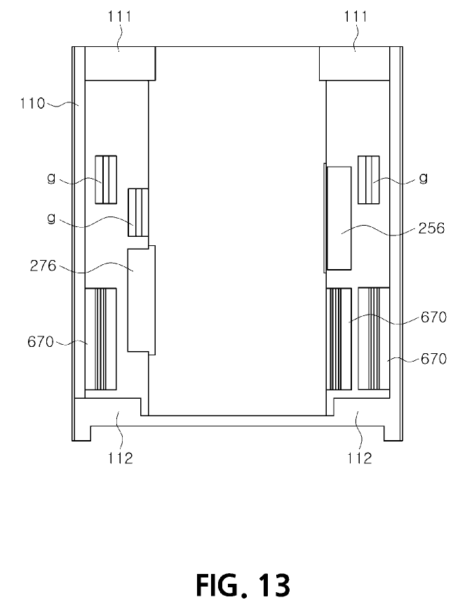

In addition, FIG. 13 is a plan view of the housing of the camera module according to an example embodiment of the present disclosure.

First, referring to FIG. 3, the first lens module 210 and the second lens module 230 may be disposed in the first housing 110. In the following description, the first housing 110 may be referred to as the housing 100.

The first lens module 210 and the second lens module 230 may be movable in the optical axis (Z-axis) direction. In an example embodiment, the first lens module 210 and the second lens module 230 may be movable together (that is, simultaneously) in the optical axis (Z-axis) direction. Alternatively, the first lens module 210 and the second lens module 230 may be independently movable in the optical axis (Z-axis) direction.

Any one or both of the first lens module 210 and the second lens module 230 may move to change a distance between the first lens module 210 and the second lens module 230, thereby implementing the optical zoom function.

In addition, any one or both of the first lens module 210 and the second lens module 230 may move to implement the focus adjustment function.

The first lens module 210 may include one or more lenses and a first lens barrel 211. One or more lenses may be disposed inside the first lens barrel 211.

In an example embodiment, the first lens module 210 may further include a first carrier 213 to which the first lens barrel 211 is coupled. For example, the first lens barrel 211 may accommodate one or more lenses, the first carrier 213 may provide a space in which a driving unit is mounted, and the first lens barrel 211 and the first carrier 213 may be coupled to form the first lens module 210.

Alternatively, the first lens module 210 may not include the first carrier 213, and in this case, the first lens barrel 211 may accommodate one or more lenses and provide a space in which the driving unit is mounted.

When the first lens module 210 includes one or more lenses and the first lens barrel 211, "a side surface of the first lens module 210" may be used in the same meaning as "a side surface of the first lens barrel 211."

When the first lens module 210 further includes the first carrier 213, "a side surface of the first lens module 210" may be used in the same meaning as "a side surface of the first carrier 213."

The first lens module 210 may include one side surface and another side surface. The one side surface and the other side surface of the first lens module 210 may be spaced apart from each other in a direction perpendicular to the optical axis (Z-axis). For example, the one side surface and the other side surface of the first lens module 210 may be spaced apart from each other in the first axis (X-axis) direction.

The first lens module 210 may have one side and another side asymmetric with each other about the optical axis (Z-axis).

In an example embodiment, the first lens module 210 may have a length of the one side surface that is greater than a length of the other side surface. For example, the length of the one side surface of the first lens module 210 in the optical axis (Z-axis) direction may be greater than the length of the other side surface of the first lens module 210 in the optical axis (Z-axis) direction.

The second lens module 230 may include one or more lenses and a second lens barrel 231. One or more lenses may be disposed inside the second lens barrel 231.

In an example embodiment, the second lens module 230 may further include a second carrier 233 to which the second lens barrel 231 is coupled. Description of the second carrier 233 may be the same as the above description of the first carrier 213 and further details may be omitted here.

The second lens module 230 may include one side surface and another side surface. The one side surface and the other side surface of the second lens module 230 may be spaced apart from each other in a direction perpendicular to the optical axis (Z-axis). For example, the one side surface and the other side surface of the second lens module 230 may be spaced apart from each other in the first axis (X-axis) direction.

The second lens module 230 may have one side and another side asymmetric with each other about the optical axis (Z-axis).

The second lens module 230 may have a length of the one side surface that is greater than a length of the other side surface. For example, the length of the one side surface of the second lens module 230 in the optical axis (Z-axis) direction may be greater than the length of the other side surface of the second lens module 230 in the optical axis (Z-axis) direction.

The first lens module 210 and the second lens module 230 may partially overlap each other.

For example, the one side surface of the first lens module 210 may directly face the second lens module 230, and the one side surface of the second lens module 230 may directly face the first lens module 210.

In an example embodiment, the one side surface of the first lens module 210 may face the other side surface of the second lens module 230, and the one side surface of the second lens module 230 may face the other side surface of the first lens module 210.

That is, a position of the one side surface (a longer side surface) of the first lens module 210 and a position of the one side surface (a longer side surface) of the second lens module 230 may be opposite to each other with respect to the optical axis (Z-axis).

A first driving unit 250 may be disposed at the one side surface of the first lens module 210, and a second driving unit 270 may be disposed at the one side surface of the second lens module 230.

That is, the driving unit may be disposed at the longer side surface of each lens module, thereby reducing the distance between the first lens module 210 and the second lens module 230 without reducing a size of the driving unit.

Even when a size of each lens module is reduced for miniaturization of the camera module, a size of a magnet included in the driving unit may be difficult to reduce in order to secure a stable driving force. That is, a size of a portion in which the magnet is mounted in each lens module may be difficult to reduce.

In this example embodiment, the first lens module 210 and the second lens module 230 may have shapes opposite to each other with respect to the optical axis (Z-axis), and the one side surface having the longer length of the first lens module 210 and the one side surface having the longer length of the second lens module 230 may be disposed at opposite sides, thereby achieving miniaturization of the camera module without reducing a size of the driving unit.

A buffer member 170 may be disposed between the first lens module 210 and the second lens module 230. The buffer member 170 may be disposed in plurality. In an example embodiment, the buffer member 170 may be disposed on at least one of the surfaces of the first lens module 210 and the second lens module 230 facing each other in the optical axis (Z-axis) direction.

The housing 100 may include a first partition wall 111 disposed in front of the first lens module 210. The first partition wall 111 may face the first lens module 210 and the second lens module 230 in the optical axis (Z-axis) direction.

The buffer member 170 may be disposed between the first lens module 210 and the first partition wall 111. In an example embodiment, the buffer member 170 may be disposed on at least one of the surfaces of the first lens module 210 and the first partition wall 111 facing each other in the optical axis (Z-axis) direction.

The buffer member 170 may also be disposed between the second lens module 230 and the first partition wall 111. In an example embodiment, the buffer member 170 may be disposed on at least one of the surfaces of the second lens module 230 and the first partition wall 111 facing each other in the optical axis (Z-axis) direction.

The housing 100 may include a second partition wall 112 disposed at the rear of the second lens module 230. The second partition wall 112 may face the first lens module 210 and the second lens module 230 in the optical axis (Z-axis) direction.

The buffer member 170 may be disposed between the second lens module 230 and the second partition wall 112. In an example embodiment, the buffer member 170 may be disposed on at least one of the surfaces of the second lens module 230 and the second partition wall 112 facing each other in the optical axis (Z-axis) direction.

The buffer member 170 may also be disposed between the first lens module 210 and the second partition wall 112. In an example embodiment, the buffer member 170 may be disposed on at least one of the surfaces of the first lens module 210 and the second partition wall 112 facing each other in the optical axis (Z-axis) direction.

The buffer member 170 may be formed of a material having elasticity.

A first driving unit 250 may be provided to move the first lens module 210 in the optical axis (Z-axis) direction.

The first driving unit 250 may include a first magnet 251 and a first coil 252, and may be disposed at the one side of the first lens module 210.

The first magnet 251 may be disposed in one of the first lens module 210 and the housing 100.

In an example embodiment, the first magnet 251 may be mounted in the first lens module 210. For example, the first magnet 251 may be disposed at the one side surface of the first lens module 210.

The first coil 252 may face the first magnet 251 in a direction perpendicular to the optical axis (Z-axis) direction. For example, the first coil 252 may face the first magnet 251 in the first axis (X-axis) direction.

In an example embodiment, the housing 100 may include a through hole in which the first coil 252 is disposed, and the first coil 252 may be disposed in the through hole to face the first magnet 251 in the first axis (X-axis) direction. The first coil 252 may be disposed on a substrate 150 coupled to the housing 100.

One surface of the first magnet 251 facing the first coil 252 may be magnetized to have a plurality of polarities. In an example embodiment, the one surface of the first magnet 251 may have a North pole (N pole) and a South pole (S pole) along the optical axis (Z-axis) direction.

The first magnet 251 and the first coil 252 may generate a driving force in a direction perpendicular to a direction in which the first magnet 251 and the first coil 252 face each other. For example, the first magnet 251 and the first coil 252 may generate the driving force in the optical axis (Z-axis) direction.

Accordingly, the first lens module 210 may move in the optical axis (Z-axis) direction by the driving force generated from the first magnet 251 and the first coil 252.

The camera module according to an example embodiment of the present disclosure may use a closed-loop control method of sensing and feeding back a position of the first lens module 210.

Accordingly, a first position sensor 253 may be provided to sense the position of the first lens module 210.

The first position sensor 253 may be disposed at a position enabling the first position sensor 253 to detect a magnetic field generated from the first magnet 251. In an example embodiment, the first position sensor 253 may face the first magnet 251. The first position sensor 253 may be a Hall sensor.

In an example embodiment, the first position sensor 253 may be disposed inside the first coil 252 or outside the first coil 252.

Although the first position sensor 253 is illustrated as being disposed inside the first coil 252, the first position sensor 253 is not limited thereto, and the first position sensor 253 may also be disposed outside the first coil 252.

The second driving unit 270 may be provided to move the second lens module 230 in the optical axis (Z-axis) direction.

The second driving unit 270 may include a second magnet 271 and a second coil 272, and may be disposed at the one side of the second lens module 230.

The second magnet 271 may be disposed in one of the second lens module 230 and the housing 100.

In an example embodiment, the second magnet 271 may be mounted in the second lens module 230. For example, the second magnet 271 may be disposed at the one side surface of the second lens module 230.

The second coil 272 may face the second magnet 271 in a direction perpendicular to the optical axis (Z-axis) direction. For example, the second coil 272 may face the second magnet 271 in the first axis (X-axis) direction.

In an example embodiment, the housing 100 may include a through hole in which the second coil 272 is disposed, and the second coil 272 may be disposed in the through hole to face the second magnet 271 in the first axis (X-axis) direction. The second coil 272 may be disposed on the substrate 150 coupled to the housing 100.

One surface of the second magnet 271 facing the second coil 272 may be magnetized to have a plurality of polarities. In an example embodiment, the one surface of the second magnet 271 may have an N pole and an S pole along the optical axis (Z-axis) direction.

The second magnet 271 and the second coil 272 may generate a driving force in a direction perpendicular to a direction in which the second magnet 271 and the second coil 272 face each other. For example, the second magnet 271 and the second coil 272 may generate the driving force in the optical axis (Z-axis) direction.

Accordingly, the second lens module 230 may move in the optical axis (Z-axis) direction by the driving force of the second magnet 271 and the second coil 272.

The camera module according to an example embodiment of the present disclosure may use a closed-loop control method of sensing and feeding back a position of the second lens module 230.

Accordingly, a second position sensor 273 may be provided to sense the position of the second lens module 230.

The second position sensor 273 may be disposed at a position enabling the second position sensor 273 to detect a magnetic field generated from the second magnet 271. In an example embodiment, the second position sensor 273 may face the second magnet 271. The second position sensor 273 may be a Hall sensor.

A plurality of guide parts 600 may be disposed between the first lens module 210 and the housing 100. The plurality of guide parts 600 may support movement of the first lens module 210.

The first lens module 210 may be supported by the plurality of guide parts 600 and may be movable in the optical axis (Z-axis) direction.

In an example embodiment, the plurality of guide parts 600 may include a first guide part 610, a second guide part 620, and a third guide part 630. Each of the first guide part 610 to the third guide part 630 may include one or more balls.

The first guide part 610 and the second guide part 620 may be disposed at the one side of the first lens module 210, and the third guide part 630 may be disposed at the other side of the first lens module 210.

The other side of the first lens module 210 may refer to a portion spaced apart from the one side of the first lens module 210 in the first axis (X-axis) direction.

In an example embodiment, the first guide part 610 and the second guide part 620 may be disposed closer to the one side surface of the first lens module 210 than the third guide part 630.

The third guide part 630 may be disposed closer to the other side surface of the first lens module 210 than the first guide part 610 and the second guide part 620.

The first guide part 610 and the second guide part 620 may be disposed closer to the first magnet 251 than the third guide part 630.

The first guide part 610 and the second guide part 620 may be spaced apart from each other in the optical axis (Z-axis) direction.

A virtual line connecting the first guide part 610 and the second guide part 620 and extending in the optical axis (Z-axis) direction and a virtual line extending from the third guide part 630 in the optical axis (Z-axis) direction may be spaced apart from each other in a direction perpendicular to the optical axis (Z-axis) (e.g., the first axis (X-axis) direction).

The first guide part 610 and the second guide part 620 disposed closer to the first magnet 251 may function as main guides for guiding movement of the first lens module 210.

The third guide part 630 disposed farther from the first magnet 251 than the first guide part 610 and the second guide part 620 may function as an auxiliary guide supporting movement of the first lens module 210.

The first lens module 210 may be pulled toward the housing 100 to allow balls included in the plurality of guide parts 600 to maintain contact with the first lens module 210 and the housing 100.

In an example embodiment, a first pulling part 254 may be disposed between the first lens module 210 and the housing 100. The first pulling part 254 may include a first magnetic body 255 and a second magnetic body 256 disposed to face each other.

For example, the first magnetic body 255 may be disposed in one of the first lens module 210 and the housing 100, and the second magnetic body 256 may be disposed in the other one of the first lens module 210 and the housing 100. One or both of the first magnetic body 255 and the second magnetic body 256 may be magnets.

The first magnetic body 255 and the second magnetic body 256 may face each other in a direction perpendicular to the optical axis (Z-axis) direction (e.g., the second axis (Y-axis) direction). Balls included in the plurality of guide parts 600 may be brought into contact with the first lens module 210 and the housing 100 by a magnetic force acting between the first magnetic body 255 and the second magnetic body 256.

In an example embodiment, the first magnetic body 255 may be disposed on a bottom surface of the first lens module 210, and the second magnetic body 256 may be disposed on a bottom surface of the housing 100.

The first magnetic body 255 may be disposed closer to the first guide part 610 and the second guide part 620 than to the third guide part 630.

In addition, the first magnetic body 255 may be disposed closer to the one side surface of the first lens module 210 than to the other side surface of the first lens module 210.

Referring to FIG. 8, among the plurality of guide parts 600, one or more guide parts (hereinafter referred to as a "circulation guide part") may include a plurality of balls 640. Hereinafter, the circulation guide part may be denoted by reference numeral CG.

The circulation guide part CG may have a space for accommodating the plurality of balls 640. For example, the circulation guide part CG may include a circulating path CP on which the plurality of balls 640 are movably disposed.

In an example embodiment, the circulation guide part CG may include an accommodating groove 650 and a guide protrusion 660.

The accommodating groove 650 may have a bottom surface 651 and a side surface 652. An upper portion of the accommodating groove 650 opposite to the bottom surface 651 may be open. In addition, a part of the side surface 652 of the accommodating groove 650 has an open shape. For example, an opening 653 is formed in a part of the side surface 652 of the accommodating groove 650.

In an example embodiment, the bottom surface 651 of the accommodating groove 650 may have a circular shape, an elliptical shape, or a track shape.

The guide protrusion 660 may be disposed in the accommodating groove 650 and may extend in the first axis (X-axis) direction perpendicular to the optical axis (Z-axis) direction. In an example embodiment, the guide protrusion 660 may extend from the bottom surface 651 of the accommodating groove 650 in the first axis (X-axis) direction.

The plurality of balls 640 may be disposed to surround the guide protrusion 660.

The guide protrusion 660 may include a first guide protrusion 661 and a second guide protrusion 662. The first guide protrusion 661 and the second guide protrusion 662 may be disposed adjacent to each other.

In the specification, the first guide protrusion 661 and the second guide protrusion 662 are described as mutually distinct configurations. However, the first guide protrusion 661 and the second guide protrusion 662 are not necessarily provided as mutually distinct configurations (see FIG. 12).

For example, a groove may be formed in a side surface of one guide protrusion, one side based on the groove may be referred to as the first guide protrusion 661, and the other side based on the groove may be referred to as the second guide protrusion 662.

In an example embodiment, the first guide protrusion 661 and the second guide protrusion 662 may face each other in the first axis (X-axis) direction. For example, one surface of the first guide protrusion 661 and one surface of the second guide protrusion 662 may be in contact with each other. Alternatively, one surface of the first guide protrusion 661 and one surface of the second guide protrusion 662 may be spaced apart from each other in the first axis (X-axis) direction.

The guide protrusion 660 may include a plurality of straight portions disposed parallel to each other and a plurality of curved portions connecting the plurality of straight portions to each other. In an example embodiment, each of the first guide protrusion 661 and the second guide protrusion 662 may include a plurality of straight portions and a plurality of curved portions.

The plurality of straight portions may each extend in the optical axis (Z-axis) direction and may be spaced apart from each other in the second axis (Y-axis) direction.

A length of each of the plurality of straight portions in the optical axis (Z-axis) direction may be greater than a diameter of each of the plurality of balls 640.

The plurality of straight portions may include a first straight portion SS1 and a second straight portion SS2, and the plurality of curved portions may include a first curved portion CS1 and a second curved portion CS2.

In an example embodiment, each of the first guide protrusion 661 and the second guide protrusion 662 may include the first straight portion SS1 and the second straight portion SS2, and may further include the first curved portion CS1 and the second curved portion CS2 connecting the first straight portion SS1 and the second straight portion SS2.

The first straight portion SS1 and the second straight portion SS2 may extend parallel to each other. The first curved portion CS1 may connect one side of the first straight portion SS1 and one side of the second straight portion SS2, and the second curved portion CS2 may connect another side of the first straight portion SS1 and another side of the second straight portion SS2.

A length of the first straight portion SS1 in the optical axis (Z-axis) direction may be greater than the diameter of each of the plurality of balls 640, and a length of the second straight portion SS2 in the optical axis (Z-axis) direction may be greater than the diameter of each of the plurality of balls 640.

One or more balls among the plurality of balls 640 may be in contact with each of the first guide protrusion 661 and the second guide protrusion 662.

At least one of the first guide protrusion 661 and the second guide protrusion 662 may have a stepped portion on an outer surface. For example, the first guide protrusion 661 may protrude in two stages.

In an example embodiment, the first guide protrusion 661 may include a first sub-protrusion 661a and a second sub-protrusion 661b.

The first sub-protrusion 661a may protrude from the bottom surface 651 of the accommodating groove 650, and the second sub-protrusion 661b may protrude from the first sub-protrusion 661a. A stepped portion may be formed between the first sub-protrusion 661a and the second sub-protrusion 661b.

The circulation guide part CG may further include a guide groove 670 (see FIG. 13).

The guide groove 670 may have a length in the optical axis (Z-axis) direction.

The accommodating groove 650 may be disposed in one of the housing 100 and the first lens module 210, and the guide groove 670 may be disposed in the other one of the housing 100 and the first lens module 210.

The guide groove 670 may be disposed to face the opening 653 provided in the side surface 652 of the accommodating groove 650. For example, the guide groove 670 may face the opening 653 provided in the side surface 652 of the accommodating groove 650 in the second axis (Y-axis) direction.

The circulating path CP may be defined by the accommodating groove 650, the guide protrusion 660, and the guide groove 670. In the specification, the "circulating path CP" may refer to a path along which a component moves continuously and returns to an initial position.

For example, the plurality of balls 640 may move on the circulating path CP in one direction and return to the initial position.

The plurality of balls 640 may move along the path defined by the accommodating groove 650, the guide protrusion 660, and the guide groove 670.

One portion of the circulating path CP may be defined by the accommodating groove 650, the guide protrusion 660, and the guide groove 670. Here, one portion of the circulating path CP may refer to a portion in which one or more balls among the plurality of balls 640 protrudes outward from the accommodating groove 650 and in contact with the guide groove 670.

The other portion of the circulating path CP may be defined by the accommodating groove 650 and the guide protrusion 660.

The plurality of balls 640 may be continuously circulable within the circulating path CP. In other words, the plurality of balls 640 may be continuously circulable along a circumference of the guide protrusion 660.

Here, "continuously circulable" indicates that a structure of a path on which the plurality of balls 640 are disposed is continuously circulable, and does not indicate that the plurality of balls 640 necessarily move to circulate continuously. For example, the plurality of balls 640 may be capable to circulate continuously within the circulating path CP.

A movement amount of the plurality of balls 640 may be related to a movement amount of the first lens module 210, and when the plurality of balls 640 move and return to the initial position, the first lens module 210 may be regarded as moving a large distance in the optical axis (Z-axis) direction. When the first lens module 210 moves a smaller distance than the above distance, the plurality of balls 640 may not return to the initial position.

One or more balls among the plurality of balls 640 may be in contact with both the housing 100 and the first lens module 210. In an example embodiment, one or more balls among the plurality of balls 640 may be in contact with both the guide protrusion 660 and the guide groove 670.

As the first lens module 210 moves in the optical axis (Z-axis) direction, a ball that is in contact with both the first lens module 210 and the housing 100 among the plurality of balls 640 may change.

In addition, as the first lens module 210 moves in the optical axis (Z-axis) direction, some of the plurality of balls 640 may move in a direction opposite to a direction in which the first lens module 210 moves.

In addition, a movement direction of some of the plurality of balls 640 may be opposite to a movement direction of the first lens module 210.

As the first lens module 210 moves in the optical axis (Z-axis) direction, a movement direction of some of the plurality of balls 640 may change. For example, when the first lens module 210 moves, some of the plurality of balls 640 may move in one direction and then move in a direction inclined with respect to the one direction.

In addition, as the first lens module 210 moves in the optical axis (Z-axis) direction, positions of some of the plurality of balls 640 in a direction perpendicular to the movement direction of the first lens module 210 (e.g., the second axis (Y-axis) direction) may change.

The plurality of balls 640 may include a first ball 641 and a second ball 642 spaced apart from the first ball 641. In an example embodiment, the second ball 642 may be spaced apart from the first ball 641 in the second axis (Y-axis) direction.

The first ball 641 may be in contact with both the housing 100 and the first lens module 210, and the second ball 642 may be in contact with only one of the housing 100 and the first lens module 210. The first ball 641 may be in contact with the housing 100 at two points and in contact with the first lens module 210 at two points.

In the specification, the first ball 641 may be used as a term referring to a ball among the plurality of balls 640 that is in contact with both the housing 100 and the first lens module 210, and the second ball 642 may be used as a term referring to a ball among the plurality of balls 640 that is in contact with only one of the housing 100 and the first lens module 210.

That is, as the first lens module 210 moves in the optical axis (Z-axis) direction, a ball functioning as the first ball 641 may be replaced by the second ball 642. Conversely, a ball functioning as the second ball 642 may be replaced by the first ball 641.

As the first lens module 210 moves, the plurality of balls 640 may move within the circulating path CP.

A movement direction of the first ball 641 and a movement direction of the second ball 642 may be opposite to each other.

One or more balls among the plurality of balls 640 may be exposed through the opening 653 provided in the side surface 652 of the accommodating groove 650. For example, a portion of one or more balls among the plurality of balls 640 may protrude outward from an opening 653.

The portion of one or more balls protruding outward from the opening 653 may be in contact with the guide groove 670.

The plurality of balls 640 may include one or more balls that is not exposed through the opening 653.

The circulation guide part CG may further include a cover 680 coupled to the accommodating groove 650. The cover 680 may be coupled to the accommodating groove 650 to cover an upper portion of the accommodating groove 650.

In this case, the first guide protrusion 661 may extend from the bottom surface 651 of the accommodating groove 650 in the first axis (X-axis) direction, and the second guide protrusion 662 may extend from an inner surface of the cover 680 in the first axis (X-axis) direction. When the cover 680 is coupled to the accommodating groove 650, the first guide protrusion 661 and the second guide protrusion 662 may be in contact with each other.

A space formed by coupling the cover 680 and the accommodating groove 650 may have one side open. That is, the space defined by the cover 680 and the accommodating groove 650 may have one side open due to the opening 653 provided in a part of the side surface 652 of the accommodating groove 650. Through the one open side, some of the plurality of balls 640 may protrude outward from the space formed by coupling the cover 680 and the accommodating groove 650.

In an example embodiment, the number of balls included in the plurality of balls 640 may be seven or more.

Among the plurality of guide parts 600 supporting movement of the first lens module 210, one or more guide parts may be provided as the circulation guide part CG described above.

In general, movement of a lens module in the optical axis (Z-axis) direction may be supported by rolling balls disposed in the guide groove formed to extend along the optical axis (Z-axis) direction. In such a method, when a movement amount of the lens module is large (that is, when the lens module moves a long distance in the optical axis (Z-axis) direction), a space in which the rolling balls roll may be required to be secured, which results in forming the guide groove in which the rolling balls are disposed to be significantly long.

That is, an overall size of the camera module may be required to increase in proportion to the movement amount of the lens module.

In contrast, in the circulation guide part CG according to an example embodiment of the present disclosure, the plurality of balls 640 may move continuously along the circulating path CP. That is, a size of the circulating path CP in which the plurality of balls 640 are disposed is not related to the movement amount of the first lens module 210, and a size of the camera module may thus be reduced even when the movement amount of the first lens module 210 is large.

In an example embodiment, when only one guide part (e.g., the first guide part 610) among the plurality of guide parts 600 is provided as the circulation guide part CG, each of the remaining guide parts may include one or more balls and a guide groove g in which the one or more balls is in contact with and rolls.

In an example embodiment, when only two guide parts (e.g., the first guide part 610 and the second guide part 620) among the plurality of guide parts 600 are provided as the circulation guide part CG, the remaining one guide part (e.g., the third guide part 630) may include one or more balls and the guide groove g in which the one or more balls is in contact with and rolls.

In an example embodiment, the plurality of guide parts 600 may all be provided as the circulation guide part CG.

When the camera module includes a plurality of lens modules, for example, when the camera module further includes the second lens module 230 in addition to the first lens module 210, a plurality of guide parts 700 may also be disposed between the second lens module 230 and the housing 100.

The plurality of guide parts 700 may support movement of the second lens module 230.

The second lens module 230 may be supported by the plurality of guide parts 700 and may move in the optical axis (Z-axis) direction.

In an example embodiment, the plurality of guide parts 700 may include a fourth guide part 710, a fifth guide part 720, and a sixth guide part 730. Each of the fourth guide part 710 to the sixth guide part 730 may include one or more balls.

The fourth guide part 710 and the fifth guide part 720 may be disposed at one side of the second lens module 230, and the sixth guide part 730 may be disposed at another side of the second lens module 230.

The other side of the second lens module 230 may refer to a portion spaced apart from the one side of the second lens module 230 in the first axis (X-axis) direction.

In an example embodiment, the fourth guide part 710 and the fifth guide part 720 may be disposed closer to the one side surface of the second lens module 230 than the sixth guide part 730.

The sixth guide part 730 may be disposed closer to the other side surface of the second lens module 230 than the fourth guide part 710 and the fifth guide part 720.

The fourth guide part 710 and the fifth guide part 720 may be disposed closer to the second magnet 271 than the sixth guide part 730.

The fourth guide part 710 and the fifth guide part 720 may be spaced apart from each other in the optical axis (Z-axis) direction.

A virtual line connecting the fourth guide part 710 and the fifth guide part 720 and extending in the optical axis (Z-axis) direction and a virtual line extending from the sixth guide part 730 in the optical axis (Z-axis) direction may be spaced apart from each other in a direction perpendicular to the optical axis (Z-axis) (e.g., the first axis (X-axis) direction).

Among the plurality of guide parts 700 supporting movement of the second lens module 230, one or more guide parts may be provided as the circulation guide part CG. The circulation guide part CG may have the same structure as described above, and a further detailed description thereof is thus omitted here.

The second lens module 230 may be pulled toward the housing 100 to allow balls included in the plurality of guide parts 700 to maintain contact with the second lens module 230 and the housing 100.

In an example embodiment, a second pulling part 274 may be disposed between the second lens module 230 and the housing 100. The second pulling part 274 may include a third magnetic body 275 and a fourth magnetic body 276 disposed to face each other.

A configuration of the second pulling part 274 may be the same as the configuration of the first pulling part 254, and a further detailed description thereof is thus omitted here.

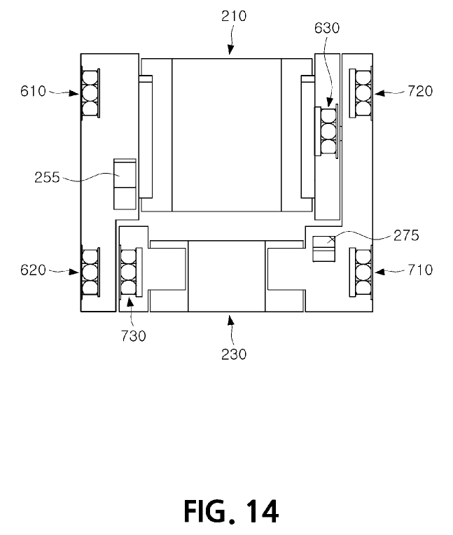

FIGS. 14 through 16 illustrate various example embodiments in which the circulation guide part is applied to the first lens module and the second lens module.

Referring to FIG. 14, the plurality of guide parts 600 supporting the first lens module 210 may all be provided as the circulation guide part CG.

In addition, the plurality of guide parts 700 supporting the second lens module 230 may also all be provided as the circulation guide part CG.

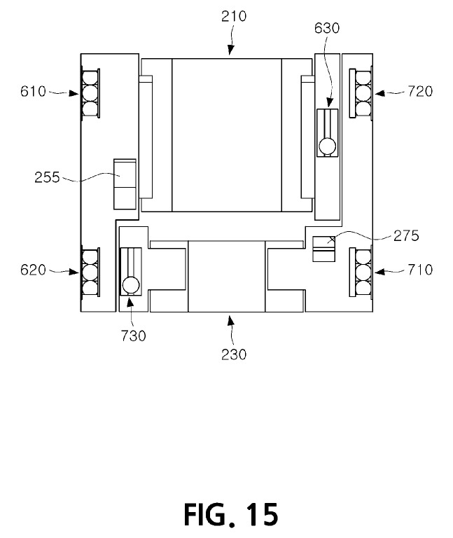

Referring to FIG. 15, among the plurality of guide parts 600 supporting the first lens module 210, the first guide part 610 and the second guide part 620 may be provided as the circulation guide part CG, and the third guide part 630 may be provided in a form including a ball and a guide groove.

Among the plurality of guide parts 700 supporting the second lens module 230, the fourth guide part 710 and the fifth guide part 720 may be provided as the circulation guide part CG, and the sixth guide part 730 may be provided in a form including a ball and a guide groove.

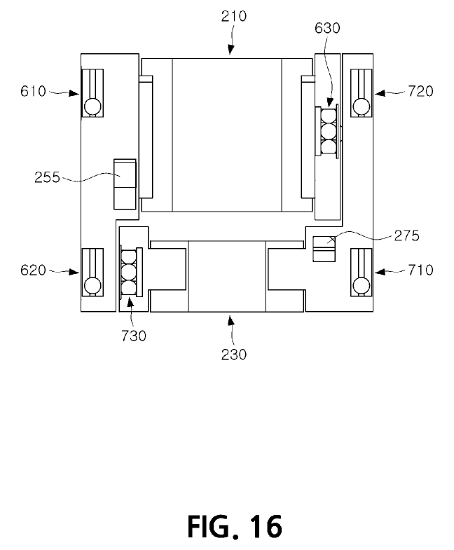

Referring to FIG. 16, among the plurality of guide parts 600 supporting the first lens module 210, the first guide part 610 and the second guide part 620 may each be provided in a form including a ball and a guide groove, and the third guide part 630 may be provided as the circulation guide part CG.

Among the plurality of guide parts 700 supporting the second lens module 230, the fourth guide part 710 and the fifth guide part 720 may each be provided in a form including a ball and a guide groove, and the sixth guide part 730 may be provided as the circulation guide part CG.

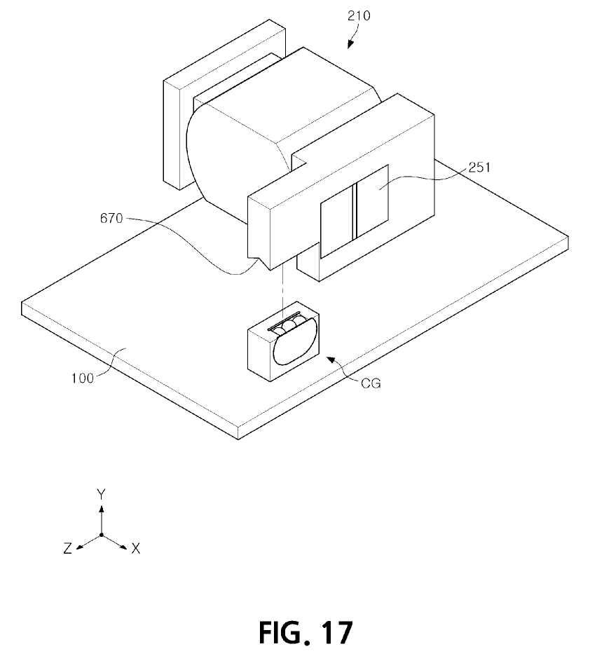

FIG. 17 is a schematic perspective view of the first lens module and the housing according to another example embodiment of the present disclosure.

Referring to FIG. 17, the guide groove 670 of the circulation guide part CG may be disposed in the first lens module 210, and the remaining components of the circulation guide part CG may be disposed in the housing 100.

In an example embodiment, an accommodating groove may be formed in a protrusion protruding from the bottom surface of the housing 100. In addition, a recess may be formed in the first lens module 210, the recess having the protrusion of the housing 100 disposed therein. The guide groove of the circulation guide part CG may be formed in the recess of the first lens module 210.

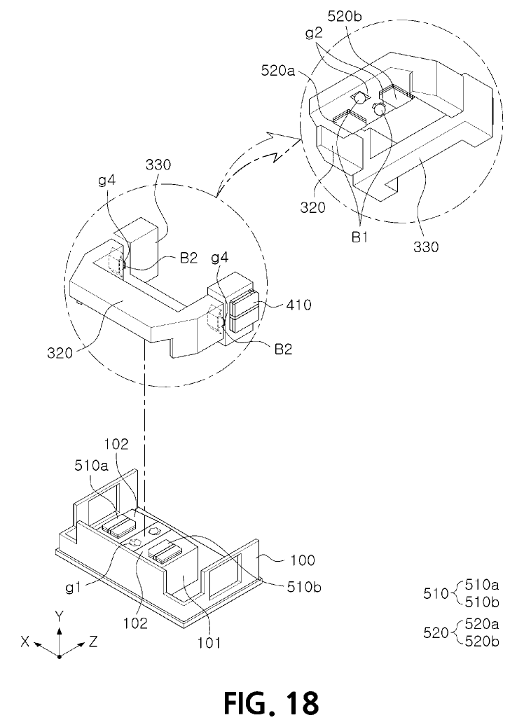

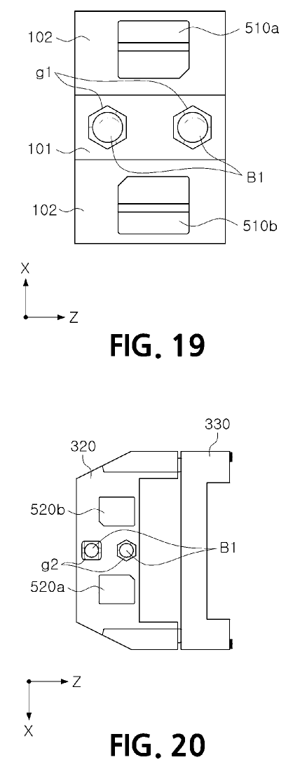

FIG. 18 is an exploded perspective view of part of the reflective module and the housing; FIG. 19 is a plan view of the protrusion of the housing; and FIG. 20 is a bottom view of the guide member and holder of the reflective module.

Referring to FIGS. 18 through 20, the reflective module 300 may include a holder 330 and a guide member 320. The reflective module 300 may further include the reflective member 310 coupled to the holder 330.

Meanwhile, in this example embodiment, the reflective module 300 and the housing 100 are described as separate members. However, the housing 100 may be provided as a component included in the reflective module 300.

The reflective member 310 may have a reflective surface reflecting light. For example, the reflective member 310 may be a prism or a mirror.

When the reflective member 310 is a prism, the reflective member 310 may have a shape of any one obtained by bisecting a rectangular parallelepiped (or a cube) in a diagonal direction. The prism may include an incident surface onto which light is incident, a reflective surface reflecting light passing through the incident surface, and an exit surface through which light reflected from the reflective surface exits.

The reflective member 310 may be mounted on the holder 330.

The holder 330 may be rotatably disposed on the guide member 320. In addition, the guide member 320 may be rotatably disposed on the housing 100.

The guide member 320 may rotate about the optical axis (Z-axis) as a rotation axis. For example, the guide member 320 may relatively rotate with respect to the housing 100 about the optical axis (Z-axis). Here, the holder 330 may also rotate together with the guide member 320. The optical axis (Z-axis) may also be referred to as a first rotation axis.

Meanwhile, for convenience of description, it is described that the guide member 320 rotates about the optical axis (Z-axis) as the rotation axis. However, the rotation axis of the guide member 320 may not be completely identical to the optical axis (Z-axis). For example, the rotation axis of the guide member 320 may be defined by a first ball member B1 described below.

The holder 330 may rotate about the first axis (X-axis) perpendicular to the optical axis (Z-axis) as a rotation axis. For example, the holder 330 may relatively rotate with respect to the guide member 320 about the first axis (X-axis). The first axis (X-axis) may also be referred to as a second rotation axis.

Meanwhile, for convenience of description, it is described that the holder 330 rotates about the first axis (X-axis) as the rotation axis. However, a rotation axis of the holder 330 may not be completely identical to the first axis (X-axis). For example, the rotation axis of the holder 330 may be defined by a second ball member B2 described below.

The reflective member 310 may be mounted on the holder 330, thereby rotating the reflective member 310 and the holder 330 together.

A third driving unit 400 may be provided to rotate the reflective module 300. The third driving unit 400 may include a first driving magnet 410 and a first driving coil 420. By the third driving unit 400, the guide member 320 may relatively rotate with respect to the housing 100 about the optical axis (Z-axis). The holder 330 may be disposed on the guide member 320, thereby also rotating the holder 330 together with the guide member 320.

The first driving magnet 410 may be mounted on the holder 330. For example, the first driving magnet 410 may be mounted on a side surface of the holder 330. The side surface of the holder 330 may refer to one surface of the holder 330 facing the housing 100 in the first axis (X-axis) direction.

The first driving magnet 410 may be magnetized to allow one surface (e.g., a surface thereof facing the first driving coil 420) to have both an N pole and an S pole. In an example embodiment, on one surface of the first driving magnet 410 facing the first driving coil 420, the N pole, a neutral region, and the S pole may be sequentially arranged along the first optical axis (Y-axis) direction.

The first driving coil 420 may be disposed to face the first driving magnet 410. In an example embodiment, the first driving coil 420 may face the first driving magnet 410 in the first axis (X-axis) direction.

The first driving coil 420 may be disposed on the substrate 150, and the substrate 150 may be mounted on the housing 100 to allow the first driving magnet 410 and the first driving coil 420 to face each other in the first axis (X-axis) direction.

The housing 100 may include a through hole passing through the housing 100 in the first axis (X-axis) direction, and the first driving coil 420 may be disposed in the through hole to directly face the first driving magnet 410.

During image stabilization, the first driving magnet 410 may serve as a moving member mounted on the holder 330 and rotated, and the first driving coil 420 may serve as a fixed member fixed to the substrate 150.

When power is applied to the third driving unit 400, the third driving unit 400 may generate a driving force required for rotation of the guide member 320 and the holder 330 about the optical axis (Z-axis) as a rotation axis. For example, the third driving unit 400 may generate the driving force in the second axis (Y-axis) direction.

The first driving magnet 410 may include a plurality of magnets. In an example embodiment, the first driving magnet 410 may include two magnets spaced apart from each other. The two magnets included in the first driving magnet 410 may be spaced apart from each other in the first axis (X-axis) direction.

One of the two magnets included in the first driving magnet 410 may be disposed at one side surface of the holder 330, and the other magnet included in the first driving magnet 410 may be disposed at another side surface of the holder 330. The one side surface and the other side surface of the holder 330 may be spaced apart from each other in the first axis (X-axis) direction.

The first driving coil 420 may include a plurality of coils. In an example embodiment, the first driving coil 420 may include two coils spaced apart from each other. The two coils included in the first driving coil 420 may be spaced apart from each other in the first axis (X-axis) direction.

In an example embodiment, one pair of magnets and coils may be disposed at the one side of the reflective module 300, and another pair of magnets and coils may be disposed at the other side of the reflective module 300.

In an example embodiment, when the guide member 320 and the holder 330 rotate about the optical axis (Z-axis) as a rotation axis, a direction of a driving force generated from the one pair of magnets and coils and a direction of a driving force generated from the other pair of magnets and coils may be opposite to each other.

For example, the guide member 320 and the holder 330 may rotate about the optical axis (Z-axis) when the direction of the driving force generated from the one pair of magnets and coils is a positive second axis (Y-axis) direction (axis direction) and the direction of the driving force generated from the other pair of magnets and coils is a negative second axis (Y-axis) direction (-Y-axis direction).

In addition, the guide member 320 and the holder 330 may rotate about the optical axis (Z-axis) when the direction of the driving force generated from the one pair of magnets and coils is the negative second axis (Y-axis) direction (-Y-axis direction) and the direction of the driving force generated from the other pair of magnets and coils is the positive second axis (Y-axis) direction (axis direction).

The first ball member B1 may be disposed between the guide member 320 and the housing 100. The first ball member B1 may be disposed between the guide member 320 and the housing 100 and form the rotation axis of the guide member 320.

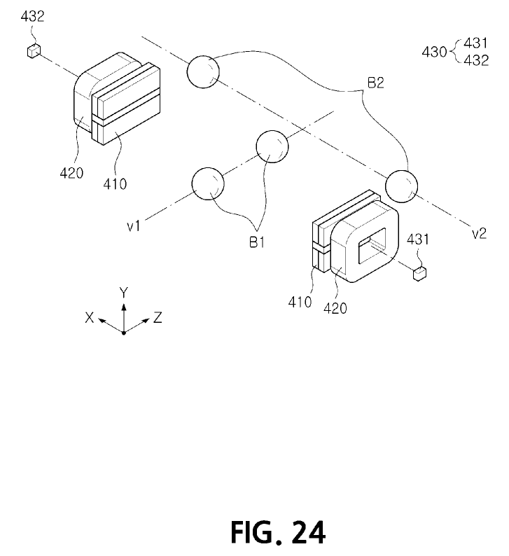

The first ball member B1 may include a plurality of balls spaced apart along the optical axis (Z-axis) direction. An imaginary line v1 connecting the plurality of balls of the first ball member B1 along the optical axis (Z-axis) direction may be spaced apart from the first driving magnet 410 in the first axis (X-axis) direction (see FIG. 24).

In an example embodiment, the first driving magnet 410 and the first driving coil 420 may be spaced apart from the first ball member B1 in the first axis (X-axis) direction. When a driving force is generated in the second axis (Y-axis) direction by the first driving magnet 410 and the first driving coil 420, the guide member 320 may rotate about a rotation axis formed by the first ball member B1.

The imaginary line v1 connecting the plurality of balls of the first ball member B1 along the optical axis (Z-axis) direction may pass through a reflective surface of the reflective member 310.

In an example embodiment, when viewed in the first axis (X-axis) direction, a line obtained by extending the optical axis (Z-axis) of the lens unit 200 may be disposed between opposite ends of the plurality of balls included in the first ball member B1. Here, the opposite ends of the plurality of balls included in the first ball member B1 may refer to opposite ends in the second axis (Y-axis) direction.

A first guide groove g1 and a second guide groove g2 may be disposed in surfaces of the guide member 320 and the housing 100 facing each other (e.g., surfaces facing each other in the second axis (Y-axis) direction). For example, the first guide groove g1 may be disposed in the housing 100, and the second guide groove g2 may be disposed in the guide member 320. The first guide groove g1 and the second guide groove g2 may face each other in the second axis (Y-axis) direction.

The first guide groove g1 may include a plurality of grooves spaced apart in the optical axis (Z-axis) direction, and the second guide groove g2 may include a plurality of grooves spaced apart in the optical axis (Z-axis) direction.

The first ball member B1 may be disposed between the first guide groove g1 and the second guide groove g2 to form the rotation axis of the guide member 320.

Among the plurality of grooves included in the second guide groove g2, one groove may be in three-point contact with the first ball member B1, and another groove among the plurality of grooves included in the second guide groove g2 may be in two-point contact with the first ball member B1. For example, referring to FIG. 20, a groove disposed on the right side among the plurality of grooves included in the second guide groove g2 may be in three-point contact with the first ball member B1, and a groove disposed on the left side among the plurality of grooves included in the second guide groove g2 may be in two-point contact with the first ball member B1.

In addition, the plurality of grooves included in the first guide groove g1 may each be in three-point contact with the first ball member B1. The first guide groove g1 and the second guide groove g2 may have shapes reversed relative to each other.

In an example embodiment, a protrusion 101 may be disposed on an inner bottom surface of the housing 100. The protrusion 101 may protrude and extend in the second axis (Y-axis) direction from the inner bottom surface of the housing 100.

The first guide groove g1 may be formed in one surface of the protrusion 101 (e.g., a surface facing the guide member 320 in the second axis (Y-axis) direction).

A magnetic force may act between the guide member 320 and the housing 100. For example, a first magnetic part 510 may be disposed on one of the guide member 320 and the housing 100, and a second magnetic part 520 may be disposed on another one of the guide member 320 and the housing 100.

In an example embodiment, the first magnetic part 510 may be disposed on the housing 100, and the second magnetic part 520 may be disposed on the guide member 320.

The first magnetic part 510 and the second magnetic part 520 may face each other in the second axis (Y-axis) direction.

In an example embodiment, the first magnetic part 510 may be disposed on an upper surface of the protrusion 101 of the housing 100, and the second magnetic part 520 may be disposed on a lower surface of the guide member 320.

The first magnetic part 510 may include a plurality of magnets spaced apart in the first axis (X-axis) direction. In an example embodiment, the first magnetic part 510 may include a third magnet 510a and a fourth magnet 510b. The third magnet 510a and the fourth magnet 510b may be spaced apart from each other in the first axis (X-axis) direction.

The first guide groove g1 may be disposed between the third magnet 510a and the fourth magnet 510b.

The second magnetic part 520 may include a plurality of magnets spaced apart in the first axis (X-axis) direction. In an example embodiment, the second magnetic part 520 may include a fifth magnet 520a and a sixth magnet 520b. The fifth magnet 520a and the sixth magnet 520b may be spaced apart from each other in the first axis (X-axis) direction.

The second guide groove g2 may be disposed between the fifth magnet 520a and the sixth magnet 520b.

The third driving unit 400 may rotate the guide member 320 and the holder 330 about the optical axis (Z-axis). That is, the guide member 320 and the holder 330 may be rotated by the third driving unit 400 about the optical axis (Z-axis).

When the guide member 320 rotates about the optical axis (Z-axis) as a rotation axis, the second magnetic part 520 coupled to the guide member 320 may serve as a moving member, and the first magnetic part 510 coupled to the housing 100 may serve as a fixed member.

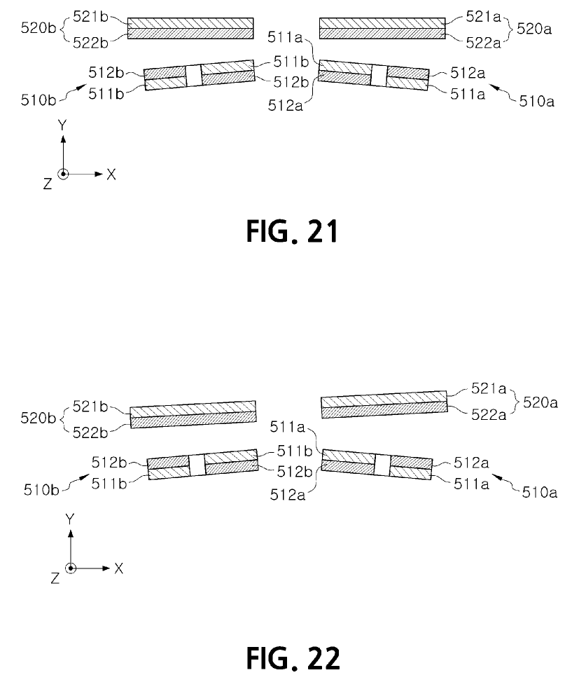

FIGS. 21 and 22 are views illustrating attractive force and repulsive force acting between the first magnetic part and the second magnetic part.

Referring to FIGS. 21 and 22, both the attractive force and the repulsive force may act between the first magnetic part 510 and the second magnetic part 520. In addition, a magnitude of the attractive force acting between the first magnetic part 510 and the second magnetic part 520 may be greater than a magnitude of the repulsive force acting between the first magnetic part 510 and the second magnetic part 520.

Accordingly, by the attractive force acting between the first magnetic part 510 and the second magnetic part 520, the first ball member B1 may maintain a state of being in contact with each of the guide member 320 and the housing 100.

Opposite ends of the second magnetic part 520 in the first axis (X-axis) direction may extend further in the first axis (X-axis) direction than opposite ends of the first magnetic part 510 in the first axis (X-axis) direction.

For example, a length between the opposite ends of the second magnetic part 520, which is a moving member, in the first axis (X-axis) direction may be greater than a length between the opposite ends of the first magnetic part 510, which is a fixed member, in the first axis (X-axis) direction.

Both the attractive force and the repulsive force may be generated between the first magnetic part 510 and the second magnetic part 520. Here, a region in which the attractive force is generated may be a central region among portions in which the first magnetic part 510 and the second magnetic part 520 face each other, and a region in which the repulsive force is generated may be an outer region in the first axis (X-axis) direction among portions in which the first magnetic part 510 and the second magnetic part 520 face each other.

The first magnetic part 510 may include a plurality of magnets spaced apart in the first axis (X-axis) direction. In an example embodiment, the first magnetic part 510 may include the third magnet 510a and the fourth magnet 510b. The third magnet 510a and the fourth magnet 510b may be spaced apart from each other in the first axis (X-axis) direction.

The second magnetic part 520 may include a plurality of magnets spaced apart in the first axis (X-axis) direction. In an example embodiment, the second magnetic part 520 may include the fifth magnet 520a and the sixth magnet 520b. The fifth magnet 520a and the sixth magnet 520b may be spaced apart from each other in the first axis (X-axis) direction.

The third magnet 510a may face the fifth magnet 520a, and the fourth magnet 510b may face the sixth magnet 520b.

The number of polarities provided on one surface of the third magnet 510a and the number of polarities provided on one surface of the fifth magnet 520a may be different from each other. For example, one surface of the third magnet 510a (e.g., a surface facing the fifth magnet 520a) may have a plurality of polarities. In addition, one surface of the fifth magnet 520a (e.g., a surface facing the third magnet 510a) may have one polarity.

The number of polarities provided on one surface of the fourth magnet 510b and the number of polarities provided on one surface of the sixth magnet 520b may be different from each other. For example, one surface of the fourth magnet 510b (e.g., a surface facing the sixth magnet 520b) may have a plurality of polarities. In addition, one surface of the sixth magnet 520b (e.g., a surface facing the fourth magnet 510b) may have one polarity.

Each of the third magnet 510a and the fourth magnet 510b may have one surface having a plurality of polarities.

For example, one surface of the third magnet 510a may have a first polarity 511a, a neutral region, and a second polarity 512a along the first axis (X-axis) direction. The first polarity 511a may be an N pole or an S pole, and the second polarity 512a may be opposite to the first polarity 511a.

On one surface of the third magnet 510a, a length of the first polarity 511a in the first axis (X-axis) direction and a length of the second polarity 512a in the first axis (X-axis) direction may be different from each other. For example, a length of a polarity formed at a position closer to the first ball member B1 (or the second optical axis (Z-axis)) in the first axis (X-axis) direction may be greater.

On one surface of the third magnet 510a, an area of the first polarity 511a and an area of the second polarity 512a may be different from each other. For example, an area of a polarity formed at a position closer to the first ball member B1 (or the second optical axis (Z-axis)) may be formed to be larger.

Another surface of the third magnet 510a may have a polarity opposite to that of the one surface of the third magnet 510a.

Meanwhile, the length or area of each of the first polarity 511a and the second polarity 512a may be measured by applying liquid iron to one surface of the third magnet 510a. For example, the length or area of each of the first polarity 511a and the second polarity 512a may be measured based on a region to which the liquid iron adheres.

One surface of the fourth magnet 510b may have a first polarity 511b, a neutral region, and a second polarity 512b along the first axis (X-axis) direction.

On one surface of the fourth magnet 510b, a length of the first polarity 511b in the first axis (X-axis) direction and a length of the second polarity 512b in the first axis (X-axis) direction may be different from each other. For example, a length of a polarity formed at a position closer to the first ball member B1 (or the second optical axis (Z-axis)) in the first axis (X-axis) direction may be greater.

On one surface of the fourth magnet 510b, an area of the first polarity 511b and an area of the second polarity 512b may be different from each other. For example, an area of a polarity formed at a position closer to the first ball member B1 (or the second optical axis (Z-axis)) may be larger.

Another surface of the fourth magnet 510b may have a polarity opposite to that of the one surface of the fourth magnet 510b.

The third magnet 510a and the fifth magnet 520a may face each other in the second axis (Y-axis) direction, and the fourth magnet 510b and the sixth magnet 520b may face each other in the second axis (Y-axis) direction.

In addition, each of the fifth magnet 520a and the sixth magnet 520b may have one surface having one polarity.

That is, the number of polarities provided on one surface of the third magnet 510a and the number of polarities provided on one surface of the fifth magnet 520a, which face each other, may be different from each other. In addition, the number of polarities provided on one surface of the fourth magnet 510b and the number of polarities provided on one surface of the sixth magnet 520b, which face each other, may be different from each other.

For example, the one surface of the fifth magnet 520a and the one surface of the sixth magnet 520b may each have the first polarity or the second polarity. In addition, a polarity provided on the one surface of the fifth magnet 520a and a polarity provided on the one surface of the sixth magnet 520b may be identical to each other.

In an example embodiment, a polarity provided on the one surface of the fifth magnet 520a may be opposite to a polarity, among polarities provided on the one surface of the third magnet 510a, disposed closer to the first ball member B1 (or the optical axis (Z-axis)). For example, when the first polarity 511a is disposed closer to the first ball member B1 than the second polarity 512a provided on the one surface of the third magnet 510a, the one surface of the fifth magnet 520a may have the second polarity 522a and the other surface of the fifth magnet 520a may have the first polarity 521a.

In addition, a polarity provided on the one surface of the sixth magnet 520b may be opposite to a polarity, among polarities provided on the one surface of the fourth magnet 510b, disposed closer to the first ball member B1. For example, when the first polarity 511b is disposed closer to the first ball member B1 than the second polarity 512b provided on the one surface of the fourth magnet 510b, the one surface of the sixth magnet 520b may have the second polarity 522b and the other surface of the sixth magnet 520b may have the first polarity 521b.

Accordingly, the attractive force may be generated in a region relatively close to the first ball member B1, and the repulsive force may be generated in a region relatively far from the first ball member B1.

When a distance between the first magnetic part 510 and the second magnetic part 520 becomes relatively close due to rotation of the holder 330, the repulsive force acting between the first magnetic part 510 and the second magnetic part 520 may increase, and the holder 330 may thus return to a neutral position in a state in which power is not applied to the reflective module 300.

Here, the neutral position may refer to a state in which the holder 330 is not rotated, for example, a state in which the first magnetic part 510 and the second magnetic part 520 are parallel to each other.

That is, in the reflective module 300 according to an example embodiment of the present disclosure, a centering structure of the holder 330 may be mechanically implemented to reduce power consumption for setting a position of the holder 330.

Accordingly, when image stabilization is not required (e.g., a state in which power is not applied to the reflective module 300), the position of the holder 330 may be adjusted without separate power consumption.

Meanwhile, an inclined surface 102 may be formed on an upper surface of the protrusion 101 of the housing 100. For example, each surface extending in the first axis (X-axis) direction from a surface in which the first guide groove g1 is formed may be the inclined surface 102.

In an example embodiment, the inclined surface 102 may be inclined downward in the first axis (X-axis) direction from the surface in which the first guide groove g1 is formed.

The third magnet 510a and fourth magnet 510b of the first magnetic part 510 may respectively be disposed on the inclined surface 102 of the protrusion 101.

In an example embodiment, a distance between the third magnet 510a and the fifth magnet 520a may vary along the first axis (X-axis) direction. In addition, a distance between the fourth magnet 510b and the sixth magnet 520b may vary along the first axis (X-axis) direction.

For example, the distance between the third magnet 510a and the fifth magnet 520a may increase toward a positive first axis (X-axis) direction (axis direction). The distance between the fourth magnet 510b and the sixth magnet 520b may increase toward a negative first axis (X-axis) direction (-X-axis direction) (see FIG. 21).

In an example embodiment, the distance between the third magnet 510a and the fifth magnet 520a in a region in which different polarities face each other may be smaller than the distance between the third magnet 510a and the fifth magnet 520a in a region in which identical polarities face each other.

The distance between the fourth magnet 510b and the sixth magnet 520b in a region in which different polarities face each other may be smaller than the distance between the fourth magnet 510b and the sixth magnet 520b in a region in which identical polarities face each other.

That is, a separation distance between the first magnetic part 510 and the second magnetic part 520 in a region in which the attractive force acts may be smaller than a separation distance between the first magnetic part 510 and the second magnetic part 520 in a region in which the repulsive force acts.

The repulsive force acting between the first magnetic part 510 and the second magnetic part 520 may enable position adjustment of the holder 330 in a state in which power is not applied to the holder 330, and may act as a driving load in a state in which power is applied to the holder 330 for image stabilization.

In this example embodiment, in a region in which the repulsive force acts, the distance between the first magnetic part 510 and the second magnetic part 520 may be greater, thereby minimizing an influence of the driving load when the guide member 320 rotates about the optical axis (Z-axis).

When the holder 330 rotates about the first axis (X-axis) as a rotation axis, the direction of the driving force generated from one pair of magnets and coils and the direction of the driving force generated from the other pair of magnets and coils may be identical to each other.

For example, the holder 330 may rotate about the first axis (X-axis) when the direction of the driving force generated from one pair of magnets and coils is the positive first optical axis (Y-axis) direction (axis direction) and the direction of the driving force generated from the other pair of magnets and coils is also the positive first optical axis (Y-axis) direction (axis direction).

In addition, the holder 330 may rotate about the first axis (X-axis) when the direction of the driving force generated from one pair of magnets and coils is the negative second axis (Y-axis) direction (-Y-axis direction) and the direction of the driving force generated from the other pair of magnets and coils is also the negative second axis (Y-axis) direction (-Y-axis direction).

In addition, the holder 330 may rotate in the diagonal direction. For example, the guide member 320 and the holder 330 may rotate together about the optical axis (Z-axis), and the holder 330 may rotate about the first axis (X-axis), thereby rotating the holder 330 in the diagonal direction.

In an example embodiment, the holder 330 may rotate in the diagonal direction by generating the driving force only from one pair of magnets and coils and not generating the driving force from the other pair of magnets and coils. Alternatively, the holder 330 may rotate in the diagonal direction by allowing the driving force generated from one pair of magnets and coils and the driving force generated from the other pair of magnets and coils to have different magnitudes (and/or directions).

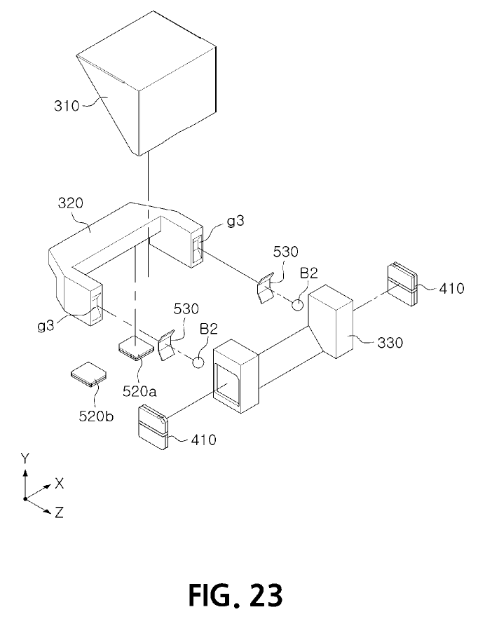

FIG. 23 is an exploded perspective view of the reflective module; and FIG. 24 is a view illustrating a positional relationship among the first driving unit, the first ball member, and the second ball member.

The second ball member B2 may be disposed between the guide member 320 and the holder 330. The second ball member B2 may be disposed between the guide member 320 and the holder 330 to form the rotation axis of the holder 330.

The second ball member B2 may include a plurality of balls spaced apart along the first axis (X-axis) direction. An imaginary line v2 connecting the plurality of balls included in the second ball member B2 along the first axis (X-axis) direction may be spaced apart from the first driving magnet 410 in the optical axis (Z-axis) direction (see FIG. 24).

In an example embodiment, the first driving magnet 410 and the first driving coil 420 may be spaced apart from the second ball member B2 in the optical axis (Z-axis) direction. When the driving force is generated in the second axis (Y-axis) direction by the first driving magnet 410 and the first driving coil 420, the holder 330 may rotate about a rotation axis formed by the second ball member B2.

The imaginary line connecting the plurality of balls of the second ball member B2 along the first axis (X-axis) direction may pass through the reflective surface of the reflective member 310.

In an example embodiment, when viewed in the first axis (X-axis) direction, a virtual line obtained by extending the optical axis (Z-axis) of the first lens module 210 may be disposed between opposite ends of the plurality of balls included in the second ball member B2. Here, the opposite ends of the plurality of balls included in the second ball member B2 may refer to opposite ends in the second axis (Y-axis) direction.

A third guide groove g3 and a fourth guide groove g4 may be disposed on surfaces of the guide member 320 and the holder 330 facing each other (e.g., surfaces facing each other in the optical axis (Z-axis) direction). For example, the third guide groove g3 may be disposed in the guide member 320, and the fourth guide groove g4 may be disposed in the holder 330. The third guide groove g3 and the fourth guide groove g4 may face each other in the optical axis (Z-axis) direction.

The third guide groove g3 may include a plurality of grooves spaced apart in the first axis (X-axis) direction, and the fourth guide groove g4 may include a plurality of grooves spaced apart in the first axis (X-axis) direction.

The second ball member B2 may be disposed between the third guide groove g3 and the fourth guide groove g4 to form the rotation axis of the holder 330.

The attractive force may act between the guide member 320 and the holder 330. For example, the holder 330 may be pulled toward the guide member 320, and the second ball member B2 may thus maintain a state of being in contact with the guide member 320 and the holder 330, respectively.

In an example embodiment, a pulling yoke 530 may be disposed on the guide member 320.

The pulling yoke 530 may face the first driving magnet 410. For example, at least a portion of the pulling yoke 530 may face the first driving magnet 410 in the optical axis (Z-axis) direction.

The pulling yoke 530 may be formed of a magnetic material. Accordingly, the attractive force may act between the first driving magnet 410 and the pulling yoke 530 in the optical axis (Z-axis) direction.

The holder 330 may be pulled toward the guide member 320 by the attractive force acting between the first driving magnet 410 and the pulling yoke 530.

In this example embodiment, a pulling force may be provided to the holder 330 by disposing the pulling yoke 530 at a position facing the first driving magnet 410 even without providing a separate pulling magnet.

In an example embodiment, the pulling yoke 530 may be disposed in the third guide groove g3 of the guide member 320. For example, the pulling yoke 530 may be mounted in the third guide groove g3 to form a bottom surface of the third guide groove g3. That is, the pulling yoke 530 may be disposed in the third guide groove g3 to form a contact surface with the second ball member B2. Accordingly, the second ball member B2 may be in contact with the pulling yoke 530.

The second ball member B2 may be in contact with the pulling yoke 530, thereby preventing damage to the third guide groove g3 even when an impact or the like occurs.

In an example embodiment, the pulling yoke 530 may be integrally formed with the guide member 320 by using an insert-injection molding method. Accordingly, the pulling yoke 530 may be embedded in the guide member 320 to expose a surface of the pulling yoke 530 to an exterior of the guide member 320.

The camera module may detect a position of the reflective member 310. For example, the reflective member 310 may be mounted on the holder 330, and the position of the reflective member 310 may thus be detected by sensing a position of the holder 330.

The camera module may include a third position sensor 430. The third position sensor 430 may be disposed at a position enabling the third position sensor 430 to detect a position of the first driving magnet 410 (for example, a position at which a magnetic field generated from the first driving magnet 410 passes through the position sensor 430). In an example embodiment, the third position sensor 430 may be disposed inside the first driving coil 420 or outside the first driving coil 420.

Referring to FIG. 24, the third position sensor 430 is illustrated as being disposed inside the first driving coil 420. However, the present disclosure is not limited thereto, and the third position sensor 430 may be disposed outside the first driving coil 420.

In an example embodiment, the third position sensor 430 may include a first sub-position sensor 431 and a second sub-position sensor 432. The first sub-position sensor 431 and the second sub-position sensor 432 may be spaced apart from each other in the first axis (X-axis) direction.

The first sub-position sensor 431 may detect a position of one of the two magnets included in the first driving magnet 410, and the second sub-position sensor 432 may detect a position of the other one of the two magnets included in the first driving magnet 410.

Each of the first sub-position sensor 431 and the second sub-position sensor 432 may be a Hall sensor.

In an example embodiment, magnetization patterns of two magnets included in the first driving magnet 410 may be identical to each other. For example, each of the two magnets included in the first driving magnet 410 may be magnetized to allow a surface facing the first driving coil 420 to sequentially have an S pole, a neutral region, and an N pole along the positive second axis (Y-axis) direction (axis direction).

Hereinafter, the description describes a method of sensing a position of the holder 330 when the magnetization patterns of two magnets included in the first driving magnet 410 are identical to each other.

When the holder 330 rotates about the first axis (X-axis) as a rotation axis, the first sub-position sensor 431 and the second sub-position sensor 432 may both move away from or move closer to the same polarity. For example, due to rotation of the holder 330, the first sub-position sensor 431 and the second sub-position sensor 432 may both move away from the N pole or move closer to the S pole, or move away from the S pole or move closer to the N pole. Accordingly, signal values output from the first sub-position sensor 431 and the second sub-position sensor 432 may have the same form.

When the holder 330 rotates about the first axis (X-axis) as a rotation axis, a position of the holder 330 may be accurately detected by performing a sum operation on signal values output from the first sub-position sensor 431 and the second sub-position sensor 432.

When the holder 330 rotates about the optical axis (Z-axis) as a rotation axis, if the first sub-position sensor 431 becomes closer to the N pole and farther from the S pole, the second sub-position sensor 432 may be closer to the S pole and farther from the N pole. Accordingly, a signal value output from the first sub-position sensor 431 and a signal value output from the second sub-position sensor 432 may have different forms.

For example, when the signal value output from the first sub-position sensor 431 has a form of an upward-sloping straight line, the signal value output from the second sub-position sensor 432 may have a form of a downward-sloping straight line. That is, graphs of the signal values output from the first sub-position sensor 431 and the second sub-position sensor 432 may form, for example, an X shape.

When the holder 330 rotates about the optical axis (Z-axis) as a rotation axis, a position of the holder 330 may be accurately detected by performing a difference operation on signal values output from the first sub-position sensor 431 and the second sub-position sensor 432.

In an example embodiment, magnetization patterns of two magnets included in the first driving magnet 410 may be different from each other. For example, among two magnets of the first driving magnet 410, one magnet may have a surface facing the first driving coil 420 and sequentially having an S pole, a neutral region, and an N pole along the positive second axis (Y-axis) direction (axis direction). The other magnet of the two magnets included in the first driving magnet 410 may have a surface facing the first driving coil 420 and sequentially having an N pole, a neutral region, and an S pole along the positive second axis (Y-axis) direction (axis direction).

Hereinafter, the description describes a method of sensing a position of the holder 330 when magnetization patterns of two magnets of the first driving magnet 410 are different from each other.

When the holder 330 rotates about the first axis X as a rotation axis, if the first sub-position sensor 431 becomes closer to the N pole and farther from the S pole, the second sub-position sensor 432 may be closer to the S pole and farther from the N pole. Accordingly, a signal value output from the first sub-position sensor 431 and a signal value output from the second sub-position sensor 432 may have different forms.

For example, when a signal value output from the first sub-position sensor 431 has a form of an upward-sloping straight line, a signal value output from the second sub-position sensor 432 may have a form of a downward-sloping straight line.

Accordingly, when the holder 330 rotates about the first axis X as a rotation axis, a position of the holder 330 may be accurately detected by performing a difference operation on signal values output from the first sub-position sensor 431 and the second sub-position sensor 432.

When the holder 330 rotates about the optical axis Z as a rotation axis, the first sub-position sensor 431 and the second sub-position sensor 432 may both move closer to or move away from the same polarity. For example, due to rotation of the holder 330, the first sub-position sensor 431 and the second sub-position sensor 432 may both move away from the N pole or move closer to the S pole, or both move away from the S pole or move closer to the N pole. Accordingly, the signal values output from the first sub-position sensor 431 and the second sub-position sensor 432 may have the same form.

Accordingly, when the holder 330 rotates about the optical axis Z as a rotation axis, a position of the holder 330 may be accurately detected by performing a sum operation on signal values output from the first sub-position sensor 431 and the second sub-position sensor 432.

As set forth above, according to the example embodiments of the present disclosure, miniaturization of the camera module may be achieved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a first lens module disposed in the housing and movable relative to the housing in an optical-axis direction; and
a plurality of guide parts configured to support movement of the first lens module,
wherein one or more guide parts among the plurality of guide parts comprises:
an accommodating groove;
a guide protrusion disposed in the accommodating groove and extending in a first-axis direction perpendicular to the optical-axis direction; and
a plurality of balls disposed to surround the guide protrusion.

2. The camera module according to claim 1, wherein the plurality of balls comprises:
a first ball in contact with both the first lens module and the housing; and
a second ball spaced apart from the first ball in a second-axis direction perpendicular to both the optical-axis direction and the first-axis direction.

3. The camera module according to claim 2, wherein a movement direction of the first ball is opposite to a movement direction of the second ball.

4. The camera module according to claim 1, wherein, as the first lens module moves in the optical-axis direction, at least one ball among the plurality of balls moves in a direction opposite to a movement direction of the first lens module.

5. The camera module according to claim 1, wherein, as the first lens module moves in the optical-axis direction, at least one ball among the plurality of balls changes a position thereof in a second-axis direction perpendicular to both the optical-axis direction and the first-axis direction.

6. The camera module according to claim 1, wherein the plurality of balls are continuously circulable along a circumference of the guide protrusion.

7. The camera module according to claim 1, wherein the accommodation groove is disposed in one of the housing and the first lens module,
wherein a guide groove is disposed in another of the housing and the first lens module, and
wherein at least one of the plurality of balls is in contact with both the guide protrusion and the guide groove.

8. The camera module according to claim 1, wherein the plurality of balls comprise a first ball in contact with both the first lens module and the housing, and
wherein a portion of the first ball is exposed to an exterior of the accommodation groove.

9. The camera module according to claim 1, wherein the guide protrusion comprises a plurality of straight portions disposed parallel to each other and a plurality of curved portions connecting the plurality of straight portions to each other.

10. The camera module according to claim 9, wherein a length of each of the plurality of straight portions is greater than a diameter of each of the plurality of balls.

11. The camera module according to claim 1, wherein the plurality of balls comprise a first ball in contact with both the first lens module and the housing,
wherein the guide protrusion comprises a first guide protrusion and a second guide protrusion disposed adjacent to each other in the first-axis direction, and
wherein the first ball is in contact with each of the first guide protrusion and the second guide protrusion.

12. The camera module according to claim 1, wherein the one or more guide parts further comprises a cover coupled to the accommodation groove,
wherein the guide protrusion comprises a first guide protrusion extending from a bottom surface of the accommodation groove in the first-axis direction, and
wherein the cover comprises a second guide protrusion extending toward the first guide protrusion.

13. The camera module according to claim 12, wherein each of the plurality of balls is in contact with each of the first guide protrusion and the second guide protrusion.

14. The camera module according to claim 12, wherein a space defined by the accommodation groove and the cover has one side open.

15. The camera module according to claim 14, wherein at least one ball among the plurality of balls is exposed to an exterior of the space defined by the accommodation groove and the cover through the one open side.

16. The camera module according to claim 1, wherein the plurality of guide parts comprise:
a first guide part and a second guide part spaced apart from each other in the optical axis direction and configured to support one side of the first lens module; and
a third guide part configured to support another side of the first lens module, the other side being spaced apart from the one side of the first lens module in the first-axis direction.

17. The camera module according to claim 1, further comprising a second lens module disposed in the housing and movable relative to the housing in the optical-axis direction,
wherein the plurality of guide parts are further configured to support movement of the second lens module.

18. The camera module according to claim 1, wherein the number of the plurality of balls is seven or more.

19. A camera module comprising:
a housing;
a lens module configured to be movable relative to the housing in an optical axis direction; and
a plurality of guide parts configured to support movement of the lens module,
wherein the plurality of guide parts comprise:
a first guide part and a second guide part spaced apart from each other in the optical axis direction and configured to support one side of the lens module; and
a third guide part configured to support another side of the lens module, and
wherein one or more guide parts among the first guide part to the third guide part comprises:
a plurality of balls; and
a circulating path in which the plurality of balls are disposed.

20. The camera module according to claim 19, wherein the one or more guide parts further comprises:
an accommodating groove disposed in one of the housing and the lens module;
a guide groove disposed in another of the housing and the lens module; and
a guide protrusion disposed in the accommodating groove and extending in a direction perpendicular to the optical axis direction, and
wherein the circulating path is defined by the accommodating groove, the guide protrusion, and the guide groove.

21. The camera module according to claim 19, wherein, as the lens module moves in the optical axis direction, a ball that is in contact with both the lens module and the housing among the plurality of balls changes.

22. A camera module comprising:
a lens module configured to be disposed in a housing and movable relative to the housing in an optical-axis direction; and
a guide part configured to support movement of the lens module,
wherein the guide part comprises:
an accommodating groove;
a guide protrusion disposed in the accommodating groove and extending in a first-axis direction perpendicular to the optical-axis direction; and
a plurality of balls configured to circulate continuously about the guide protrusion.

23. The camera module according to claim 22, wherein, the plurality of balls comprise:
a first ball configured to support the lens module on the housing; and
a second ball spaced apart from the first ball in a second-axis direction perpendicular to both the optical-axis direction and the first-axis direction.

24. The camera module according to claim 22, comprising:
one or more of a first guide part and a second guide part spaced apart from each other in the optical axis direction and configured to support one side of the lens module; and
a third guide part configured to support another side of the lens module, the other side being spaced apart from the one side of the lens module in the first-axis direction,
wherein one or more of the first guide part to the third guide part comprises the guide part.
